(19) United States
(12) Patent Application Publication
(10) Pub. No.: US 2012/0283973 A1
(43) Pub. Date: Nov. 8, 2012

(54) PLASMA PROBE AND METHOD FOR PLASMA DIAGNOSTICS

(75) Inventors: VLADIMIR SAMARA, LEUVEN (BE); JEAN-FRANÇOIS DE MARNEFFE, GOTTECHAIN (BE); WERNER BOULLART, BINKOM (BE)

(73) Assignee: IMEC, LEUVEN (BE)

(21) Appl. No.: 13/464,679

(22) Filed: May 4, 2012

Related U.S. Application Data
(60) Provisional application No. 61/482,980, filed on May 5, 2011.

(51) Int. Cl. G01N 27/62; G06F 19/00

(52) U.S. Cl. 702/65; 324/71.1

(57) ABSTRACT

Device and method for monitoring a plasma in a chamber of a plasma reactor is are disclosed. In one aspect, the method includes measuring plasma parameter data at a surface of a single planar Langmuir probe in contact with the plasma. A biasing capacitor is connected between the single planar Langmuir probe and a DC-bias source. Subsequently a discharge current of the biasing capacitor as a result of the DC-bias is measured, and a probe potential at the single probe during the discharge is measured. The measurements can be used to detect presence and/or thickness of a dielectric film on the probe surface.

### CROSS REFERENCE TO RELATED APPLICATIONS

This application claims priority under 35 U.S.C. §119(e) to U.S. provisional patent application 61/482,980 filed on May 5, 2011, which application is hereby incorporated by reference in its entirety.

### BACKGROUND OF THE INVENTION

1. Field of the Invention

The disclosed technology relates to a device and method for plasma diagnosis (the monitoring of plasma parameter data, such as positive ions flux and/or electron flux), and more specifically, relates to a DC pulsed Langmuir probe suitable to be used for plasma diagnostics in a semiconductor manufacturing tool.

2. Description of the Related Technology

In industrial plasma processing it would be useful to directly control plasma properties like plasma potential, density, ion flux etc. Unfortunately, conventional probes used in research often do not comply with industrial processes or are too complex for routine exploitation.

The Langmuir probe is one of the most important techniques in plasma diagnostics, but its implementation into industrial plasma chambers is difficult for two main reasons: unwanted perturbation and contamination of the plasma and limitation of the technique because of deposits on the probe.

U.S. Pat. No. 5,936,413 discloses a capacitively coupled planar Langmuir probe that can be used for plasma monitoring. The known probe monitors the ion flux arriving to the probe which is determined from the discharging of an RF-biased capacitance in series with the probe. However, this known plasma probe does not provide additional information about the plasma composition and/or quality, neither about the film deposited on the probe and/or its influence on the monitoring results. Although the dielectric film deposited on the probe does not prevent the measurements in capacitively coupled Langmuir probe as in the standard Langmuir probe, the measured signal is altered and the original fitting function cannot be applied.

US2005034811 discloses a plasma diagnostic apparatus comprising dynamically pulsed dual floating Langmuir probes. The dual planar probe is not suitable to measure the absolute values of the floating and plasma potential, nor the separate electron and ion fluxes.

Therefore it is desirable to have a plasma probe that would solve at least one of the above mentioned drawbacks.

### SUMMARY OF CERTAIN INVENTIVE ASPECTS

Certain inventive aspects relate to a method and device for monitoring a plasma in a plasma reactor which uses simpler electronics circuitry and yet does not show the limitations of the prior art.

In a first aspect, there is a method and device (also referred to as ‘DC technique’ or ‘DC pulsed’ throughout the description) which are suitable to measure separately (and subsequently) both the ion saturation current and the electron current, for probe potentials above the floating potential. It has been found that this information can be obtained by applying suitable DC levels/pulses only on a single Langmuir probe, so that simpler electronics circuitry can be used. Furthermore, it has been found that additional information can be obtained by using DC biasing, namely capacitance and thickness of a dielectric film deposited on the Langmuir probe surface.

In an embodiment, the method and device may be applying a signal to the biasing capacitor comprising positive DC-pulses suitable for charging the biasing capacitor above a floating potential of the plasma alternating with negative DC-pulses suitable for charging the biasing capacitor below a floating potential of the plasma and wherein the measuring means is provided for measuring an electron flux from the plasma to the probe during the positive DC-pulses and an ion flux from the plasma to the probe during the negative DC-pulses. The signal is preferably symmetric relative to the floating potential of the plasma, so that information on capacitance and/or thickness of the dielectric film can be determined by subtraction of the electron flux from the ion flux.

In a second aspect, there is a plasma reactor comprising a plurality of plasma monitoring devices using the DC-technique described herein, to gather information about the spatial distribution of at least one plasma parameter inside the chamber.

In a third aspect, there is a method for measuring in-situ a capacitance of a dielectric film deposited on a surface of a single Langmuir probe which is located inside a chamber of a plasma reactor in contact with a plasma, the method comprising:

a) alternatingly providing the single Langmuir probe with positive and negative DC-pulses through a biasing capacitor, the positive DC-pulses being suitable for charging the biasing capacitor above a floating potential of the plasma and the negative DC-pulses being suitable for charging the biasing capacitor below a floating potential of the plasma;

b) measuring a first probe potential during the positive DC-pulses and a second probe potential during the negative DC-pulses;

c) calculating the difference (ΔV) between the measured first floating potential and the measured second floating potential;

d) calculating the capacitance of the dielectric film (C_{film}) using the calculated difference (ΔV), the amplitude of the DC-pulses (Va) and the capacitance of the biasing capacitor (C_{bias}).

In an embodiment, the method may further comprise the step of determining the thickness of the dielectric film using the capacitance of the dielectric film (C_{film}) and known physical characteristics of the dielectric film.

### BRIEF DESCRIPTION OF THE DRAWINGS

The disclosure will be further elucidated by means of the following description and the appended figures.

FIG. 1 shows schematically an experimental set up comprising a DC pulsed planar Langmuir probe according to one embodiment of the disclosure.

FIG. 2 shows a comparison between RF pulsing and DC-pulsing: (a) the RF and DC-pulsed signal applied (b) potentials measured at the biasing capacitor for the RF and the DC-pulsed case. The discharging current is also measured but not shown.

FIG. 3 shows simulated (Wolfram Mathematica™ version 7.0) results for a DC pulsed Langmuir probe as follows. (a) Applied pulses (dashed line) and measured potential at the probe (full line). Charging the capacitor at beginning of the positive pulse by the electron pulse is marked with (1) and discharging by the ion flux is marked with (2). (b) The total current to the probe showing the ion saturation current and the electron current.

FIG. 4 shows experimental measurement with a DC pulsed probe, wherein only the ion discharging part is shown: (a) potential measured at the probe (b) discharging current through the capacitor. The measurement was performed in argon plasma, with 100 nF biasing capacitor and a probe with 0.85 cm² area.

FIG. 5 shows the probe current as function of the probe bias: dotted line—experimental data measured with a DC pulse, full-line theoretical fit according to equation (2) in the description.

FIG. 6 shows the I-V characteristic obtained by DC pulsing applied to the probe. The dots represent ion saturation current obtained (b), while the triangles represent the electron current (a). The current is shown inverted.

FIG. 7 shows limiting electron current by using a ramp DC pulse (i.e. a gradually increasing positive pulse) instead of square DC pulse. The dashed line is the applied ramp DC pulse and the thin black line the measured potential at the probe (scale on the left side). The current calculated from the potential at the capacitor is represented by the thick gray line with the scale on the right side.

FIG. 8 shows schematically the setup for determining the capacitance of a dielectric film, wherein the film formed on the probe is modeled by a capacitor connected by a dashed line, Vₐ is applied DC voltage pulse, C_{bias} is the biasing capacitor, V is potential measured by an oscilloscope with internal resistance R, while C_{film} and R_{film}, are capacitance and resistance of the film, respectively.

FIG. 9 shows comparative results, the I-V characteristic for measurements with an RF plasma probe in the presence of a dielectric film (the solid line, a) and for a clean probe, i.e. without dielectric film (the dashed line, b).

FIG. 10 shows the measured potential for a DC pulsed plasma probe in the presence of a film on the probe (b—thin film of about 1 nm SiO₂, and c—thick film of about 5 nm SiO₂) and without a film (a). Although in all cases the probe surface in contact with plasma goes to the floating potential at the end of the positive and negative pulses, the measured potentials in the case of the dielectric film are not equal due the effect of a voltage divider.

FIG. 11 shows a test mimicking a film capacitance by inserting an additional capacitor (with the capacitance ranging from 0.47 to 47 nF) in series with the biasing capacitor (4.7 nF). The values for the ‘film’ capacitance calculated from measured potentials have a good match with the real values of the additional capacitor.

FIG. 12 shows the equivalent electrical circuit used for modeling the experimental setup in case the film is a ‘leaky’ dielectric (having a certain resistivity).

FIG. 13 shows an I-V curve measured by a probe covered with a dielectric layer (silicon oxide layer on top of silicon made probe). Argon+0.5% oxygen plasma at 120 mTorr and 800 W 27 MHz CCP.

FIG. 14 shows the same as FIG. 13, but with marked the region A which can be obtained with both DC and RF pulsing, and the region B which can be obtained only by DC pulsing. A hysteresis in the region B is a clear sign that the probe (and other walls including the grounded electrode) are coated with a dielectric layer.

FIG. 15 shows experimental data which are the same as in FIG. 13 on which approximate fitting is done by fixing the floating potential to the measured value at which the current is equal to 0 and by fixing the electron temperature to 3 eV.

FIG. 16 shows a comparison of a numerical simulation and the experimental data from FIG. 13. Marked regions A and B in hysteresis with arrows indicate the direction of the time the points are collected.

### DETAILED DESCRIPTION OF CERTAIN ILLUSTRATIVE EMBODIMENTS

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

Furthermore, the various embodiments, although referred to as “preferred” are to be construed as exemplary manners in which the disclosure may be implemented rather than as limiting the scope of the disclosure.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present disclosure, the only enumerated components of the device are A and B, and further the claim should be interpreted as including equivalents of those components.

The detailed description below relates to a plasma diagnosis device and method. More specifically it relates to a DC pulsed Langmuir probe suitable to be used for plasma diagnostics in a semiconductor manufacturing tool. Plasma diagnostics is the monitoring of plasma parameter data, such as positive ions flux and/or electron flux.

The devices according to one embodiment may be arranged to measure and quantify both the positive ions flux and the electron flux from a plasma to a solid surface in contact therewith, for example a wall of a plasma reactor or a sample to be processed in the plasma reactor.

The probe of the disclosure may have a planar geometry, being herein referred further as DC pulsed planar Langmuir probe.

The probe of the disclosure may be mountable on the chamber wall (or in the grounded electrode) thereby minimizing the perturbation of the plasma. A capacitively coupled planar Langmuir probe can be made of the same material as the walls of the chamber and incorporated into the walls (or into the grounded electrode) thus further minimizing plasma perturbation.

Further certain embodiments relate to a method of monitoring and/or controlling a plasma process using the DC pulsed planar Langmuir probe. A plasma process can be in general a plasma process for modifying the structure or the chemical composition of a surface by ion bombardment or a plasma process for coating a sample with a layer. More specifically a plasma process can be a plasma etch process or plasma assisted/enhanced deposition process.

Furthermore certain embodiments relate to a method for measuring the capacitance of an insulating film deposited on the probe. More specifically when the physical properties (i.e. dielectric constant) of the deposited film are known the thickness of the deposited film can be measured/monitored in-situ.

An advantage of the DC pulsed planar Langmuir probe according to one embodiment is that simpler electronics circuitry may be used. Another advantage is that it may provide information about the electron density and/or the capacitance of the film deposited on the probe.

In various embodiments, the method comprises measuring at least one plasma parameter in real-time, monitoring the at least one plasma parameter as a function of time thereby identifying any variations and using the measured values to adjust/control the plasma process. Alternatively, the measurements can be stored in a database for later evaluation in relation with the sample (wafer) processed.

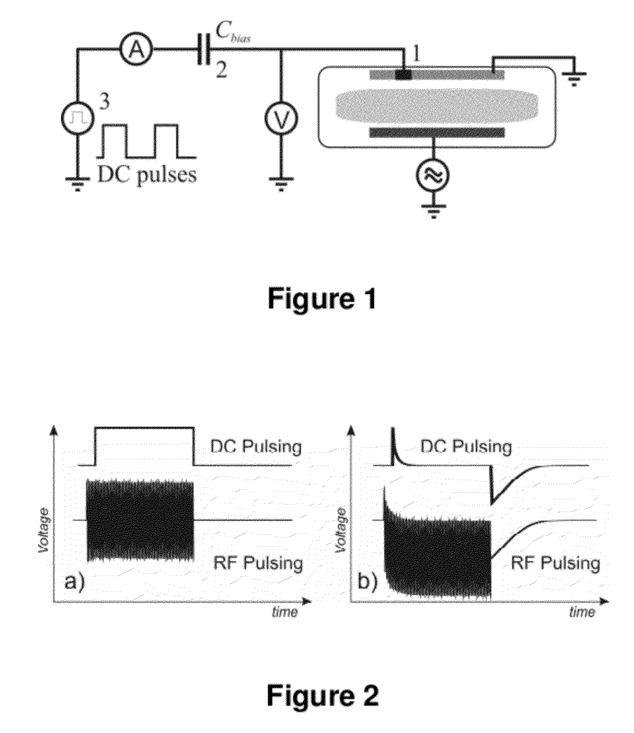

FIG. 1 shows a possible experimental setup for the DC pulsed planar Langmuir probe in one embodiment comprising: a planar probe (1) mounted in the grounded electrode which is capacitively coupled through a biasing capacitor (2) to a DC pulse generator/source (3). The probe area may range between 20 mm² to 100 cm² or more, up to the area of the whole grounded electrode which can be adapted to function as a probe. In a particular example, the probe area was about 1 cm². The capacitance of the biasing capacitor may range between 100 pF and 1000 nF, or higher in the case of high density plasmas or large area probes. In a particular example, the biasing capacitor had a capacitance of 100 nF.

The measurements were conducted in a capacitively coupled plasma (CCP) reactor with a probe having a planar geometry mounted in the grounded top electrode.

In one embodiment of the disclosure, the probe may be made of stainless steel and have a diameter of 5 mm. In other embodiment, the probe may be made of silicon with a diameter of 10 mm.

The DC technique according to one embodiment is suitable to measure separately (and subsequently) both the ion saturation current and the electron current, for probe potentials above the floating potential.

In the examples below, square DC pulses with a period from a few hundred microseconds to 500 ms and amplitude of up to 100 V were applied.

In alternative embodiments, shaped (ramp) pulses with a ramp-up time of up to 50 ms were applied (i.e. the positive pulse was gradually increased to its maximum value during up to 50 ms). In this way, the electron current at the beginning of the positive pulse can be limited, thereby limiting the plasma perturbation and protecting the circuitry.

The DC pulsing generator (3) is arranged to produce square DC pulses of at least 20 V amplitude peak to peak with a period between 1 ms and 500 ms. However, specific values may depend on the choice of the capacitor, area of the probe, contamination of the probe (i.e. the presence of a film), ion flux (i.e. plasma density) etc.

The amplitude of the DC pulse is chosen such that the potential at the probe can repeal substantially all electrons during discharge with ions. In the case of a clean probe (no film present on the probe) the amplitude may be about 20 V, but in the case of a contaminated probe (i.e. with a film deposited on the probe) higher potential may be required due effect of voltage divider generated by additional capacitance of the film.

Duty cycle (i.e. the ratio of positive part of the pulse to the pulse period) and the period of the DC pulses are preferably chosen such that the capacitor has enough time during positive part to build up DC bias by the electron flux collected on the probe and also enough time during the negative part of the pulse (i.e. between positive pulses) to discharge.

For example, in the case of a capacitively-coupled plasma (with a plasma density of about 10¹⁶ m⁻³), for a probe with an area of 1 cm² and a capacitor of 100 nF the period was about 100 ms, with the duty cycle of about 0.5.

Because of additional DC bias that is built up on the biasing capacitor and added to the applied pulses, DC pulses can be positive, negative or containing both positive and negative parts (which parts can be symmetric or asymmetric). Preferably, but not essentially, a symmetrical signal relative to the floating potential is used for measurement of the film thickness.

Comparative data including RF measurements (state of the art) and DC pulsed measurements according to one embodiment with a pulse having a positive part and a negative part are shown in FIG. 2. A clear difference can be observed during biasing the capacitor between the two regimes (i.e. during the RF pulse in the RF case or during positive part of the pulse in the DC case).

In the RF-regime, the plasma is perturbed by the RF potential during the whole pulse, while with a DC pulse the positive potential drags electrons from the plasma at the beginning of the pulse, but once the capacitor is biased and the probe is at the floating potential the plasma is not perturbed at all, irrespective of the duration of the pulse.

In the RF regime the interpretation of the signal is cumbersome due the over-imposed RF signal. When a DC-pulse is applied the interpretation is simpler and complete I-V characteristics can be obtained (containing information about both electrons and ions fluxes) even during the charging of the biasing capacitor.

During the discharging of the biasing capacitor by the ion flux (i.e. after the RF pulse is stopped in the RF case, or during the negative part of the pulse in the DC case), the behavior in both cases (RF and DC) is similar (if the capacitor is biased to the same potential) and both techniques give the same results.

Consequently, measurements of the voltage (shown in FIG. 2) and current (shown in FIG. 6) during the capacitor discharge did not present any significant difference between RF and DC-pulses.

One of the advantages of the DC-pulsed probe and method in one embodiment is that the electron current determined during the positive part of the DC-pulse complements the measurement of ion current to provide the complete I-V characteristic as shown in FIG. 6.

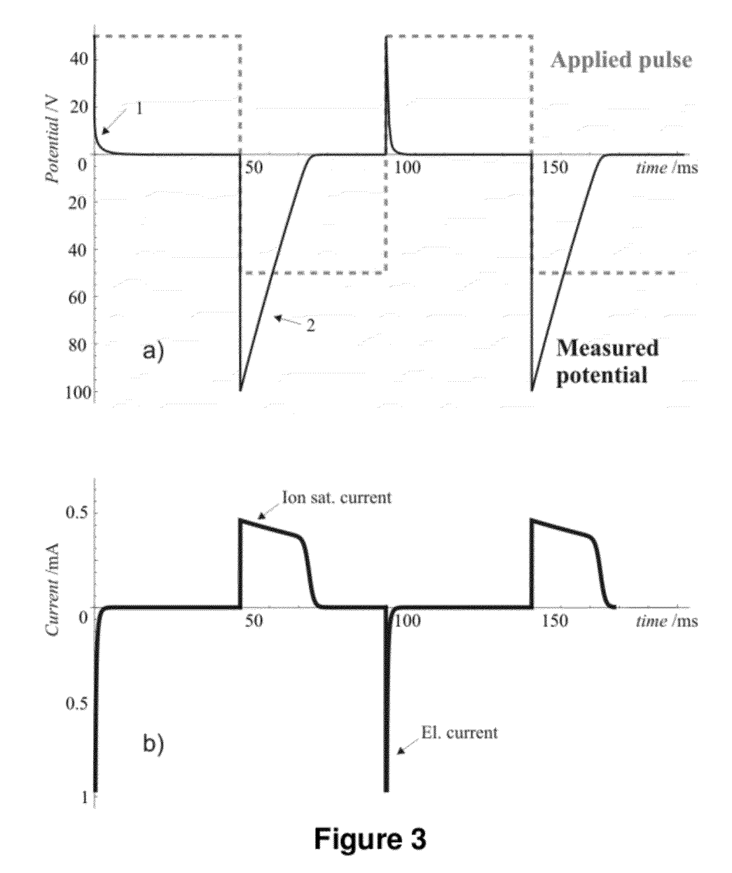

An example of the signal measured at the probe for an applied DC pulse is shown FIG. 3. The applied DC pulse (the dashed line in FIG. 3a) has a period of 100 ms, duty cycle 0.5 and amplitude of 50 V, i.e. positive part of the pulse is 50 V for the first 50 ms and then there is a negative part of 50 ms with the potential of −50 V.

As shown in FIG. 3 the capacitor is quickly biased with the relatively high electron current at the beginning of the positive pulse. After biasing, the probe is at the floating potential and the net current (i.e. a sum of the ion and the electron current) is equal to zero. After the positive pulse, both the applied potential and the probe potential become negative and electron current is completely blocked such that the total current collected at the probe consists only of the ion current.

The total current through the circuit (i.e. biasing capacitor (2)) equals the sum of electron flux and ion flux to the probe. While the ion flux is only slightly influenced by the DC-pulse applied to the probe, the electron flux is an exponential function of the applied potential relative to the plasma potential. Because the capacitor blocks any DC current, any surplus of charge is collected at the capacitor which changes potential of the probe. The potential at the probe is equal to the difference of the applied potential and the potential at the biasing capacitor:

V_{probe}=V_{applied}−V_{bias} (1)

When the capacitor is charged to biasing potential the probe will be subjected to the floating potential at which both currents (ion and electron) are equal such that the system is in equilibrium.

The experiments show that during the first few milliseconds after the positive DC-pulse is applied, the probe potential gets positive and attracts extra electrons. These extra electrons bias the capacitor negatively and the probe reaches again the floating potential and the total current to the probe is equal to zero (the solid line in FIG. 3a).

The duration of the remaining positive pulse is not important as the probe floats at the floating potential until the applied potential changes. The biasing potential is equal to V_{bias}=(V_{applied}−V_{probe}) and because V_{probe}=V_{floating}, the final value of the biasing potential at the end of the positive pulse is V_{bias}=(Vₚₒₛᵢₜᵢᵥₑ−V_{floating}), wherein Vₚₒₛᵢₜᵢᵥₑ is the positive amplitude of the applied DC pulse.

At the moment when V_{applied} changes from Vₚₒₛᵢₜᵢᵥₑ to V_{negative}, the probe potential is still given by the equation (1) above, but V_{bias}=(Vₚₒₛᵢₜᵢᵥₑ−V_{floating}) and V_{amplitude}=V_{negative}, so the probe potential is equal to V_{probe}=V_{negative} Vₚₒₛᵢₜᵢᵥₑ+V_{floating} or, in the case of the symmetric pulse, V_{probe}=−2 Vₚₒₛᵢₜᵢᵥₑ V_{floating} (as shown in FIG. 3a wherein V_{floating}=0).

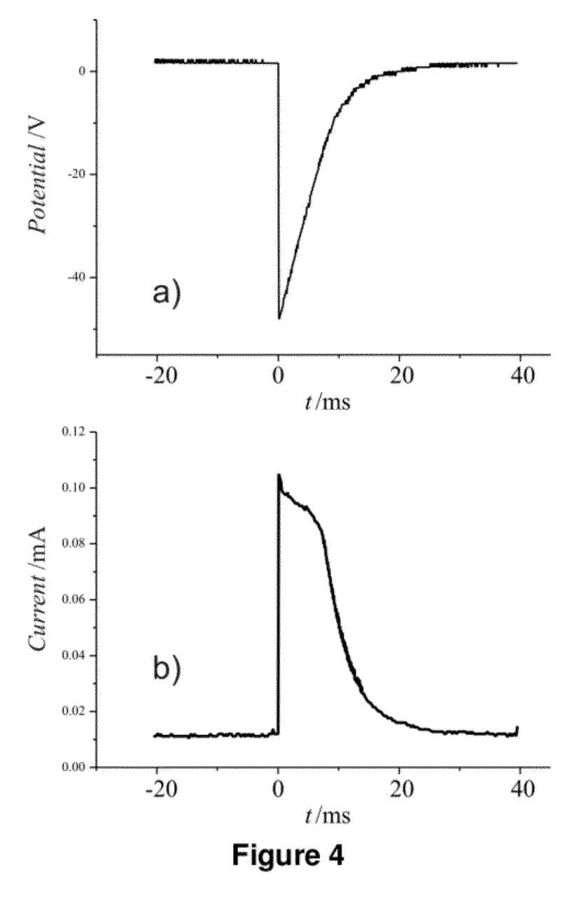

If the amplitude of the applied DC pulse is sufficient to repeal the electrons, the capacitor is discharged by the ion current (see FIG. 3b and FIG. 4) until it reaches biasing potential that will give the probe the floating potential. This discharging is similar with the RF case, therefore the same theoretical interpretation may be applied:

$$I = {I}_{0} \{ 1 - s ( V - {V}_{f} ) - exp ( \frac{V - {V}_{f}}{{kT}_{e}} ) \} \qquad ( 2 )$$

wherein I₀ is ion saturation current, V_{f} floating potential, Tₑ electron temperature and s the slope parameter (related to the edge effects).

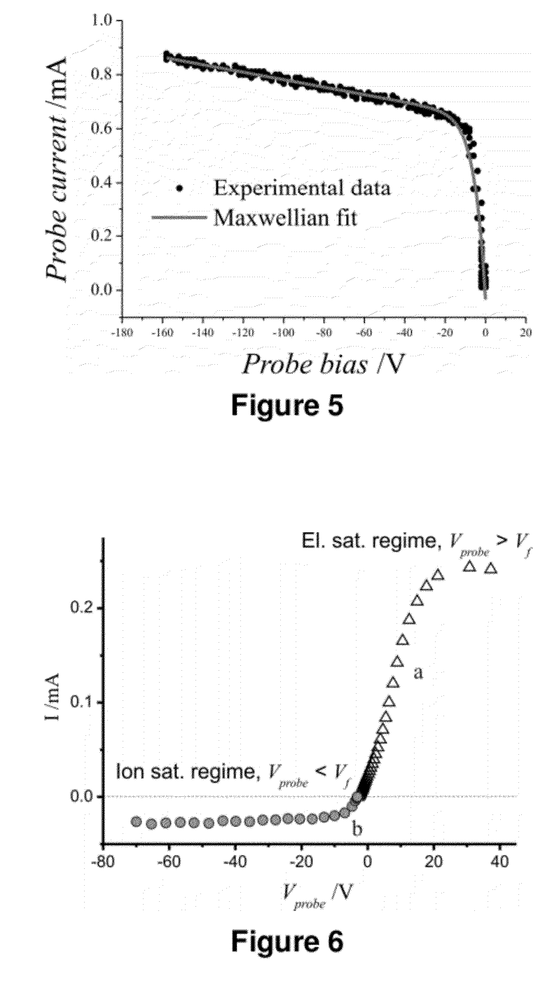

An example of fitting equation (2) to real experimental data is shown in FIG. 5. Experimental data shown in FIG. 5 are obtained by DC pulsing.

In addition to these data points (i.e. ion discharging current for potentials below the floating potential, DC pulsing can also give the Langmuir I-V characteristics needed for calculation of other plasma properties (i.e. electron transition curve, electron saturation current and the plasma potential), which is shown in FIG. 6.

As can be seen from FIGS. 3 and 6 electron current can be relatively high at the beginning of the positive pulse, but if this presents a problem for the probe electronics or the plasma perturbation, it can be limited by a gradual increase of positive potential at the beginning of the positive pulse (i.e. using a positive ramp instead of a square DC pulse). In this way the total current is limited by the rate of the increase of applied potential:

$${I}_{max} = {C}_{bias} \frac{d {V}_{applied}}{d t} \qquad ( 3 )$$

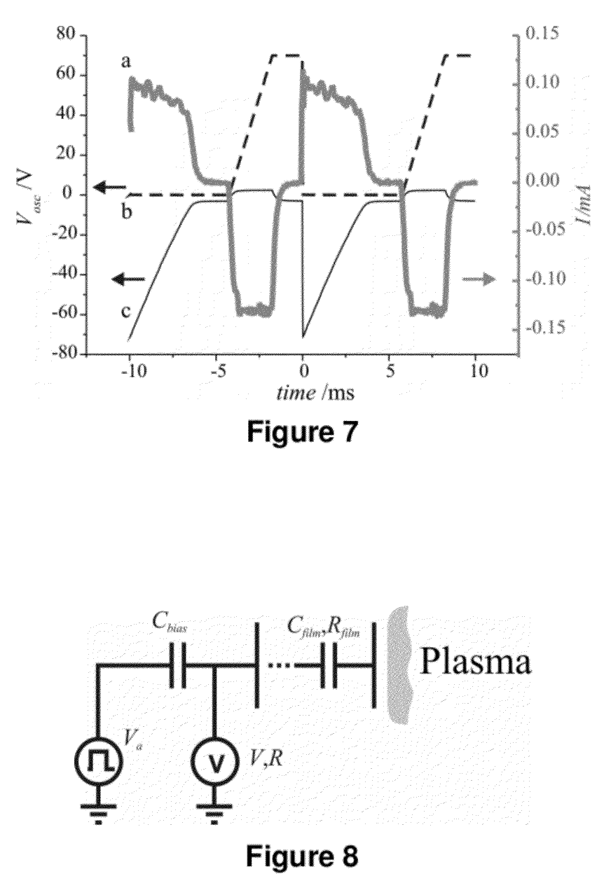

An example of measurements with a ramp DC pulse instead of the DC pulse is given in the FIG. 7.

One embodiment relates to monitoring the plasma with a dielectric film deposited on the probe. The dielectric film can be the result of the deposition/sputtering process performed in the chamber.

One of the major drawbacks of the prior art Langmuir probe measurements is that a dielectric film deposited on the probe is blocking any DC current from flowing to the probe, making the plasma monitoring not possible anymore.

This drawback can be solved by the capacitively coupled probe according to one embodiment, since the dielectric film acts as an additional capacitor in series with the biasing capacitor as shown in FIG. 8. The measured signal will change accordingly because the probe potential is not measured directly anymore but through a voltage divider formed by the biasing capacitor and the capacitor introduced by the dielectric film.

In one embodiment, measurements of the film capacitance were mimicked by adding an additional capacitance in series between the biasing capacitor and the probe.

In another embodiment, measurements with a real film over the probe (e.g. a SiO₂ layer deposited on top of the silicon probe) were performed.

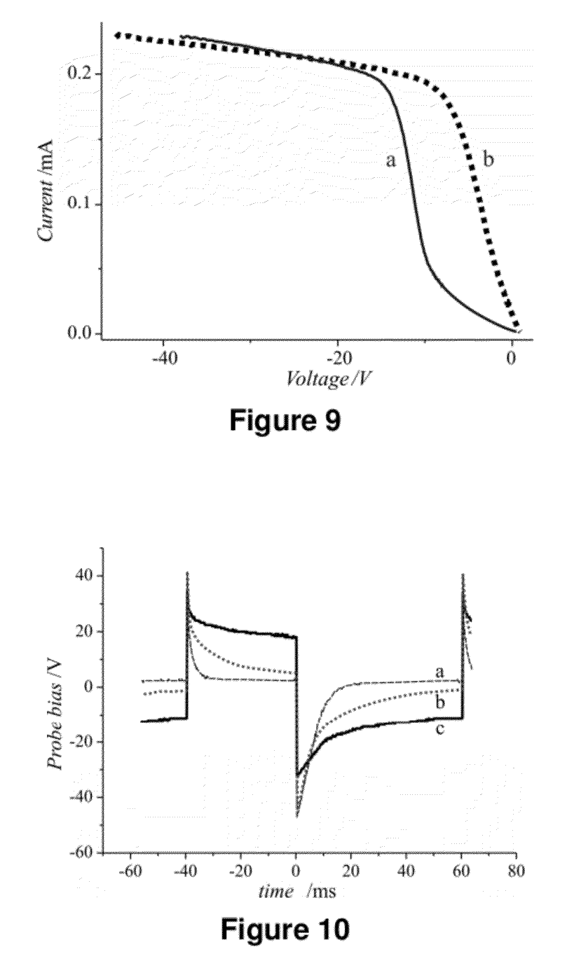

The difference between the measurements with and without the dielectric film is shown in FIG. 9. Information on the ion flux is still present, but fitting equation (2) cannot be applied anymore because it was derived for the case of direct measurements of the potential on the probe and not through a potential divider formed by the biasing capacitor and the film capacitance.

The measurements shown in FIG. 9 are obtained during discharging of the capacitor by the ion current, therefore they are illustrative for both RF-biasing (state of the art) and DC pulsing (method according to one embodiment).

Advantageously, the method in one embodiment can provide additional information on the film properties indirectly by the measurements of the floating potential through the potential divider for the positive and the negative part of the pulse as shown in FIG. 10.

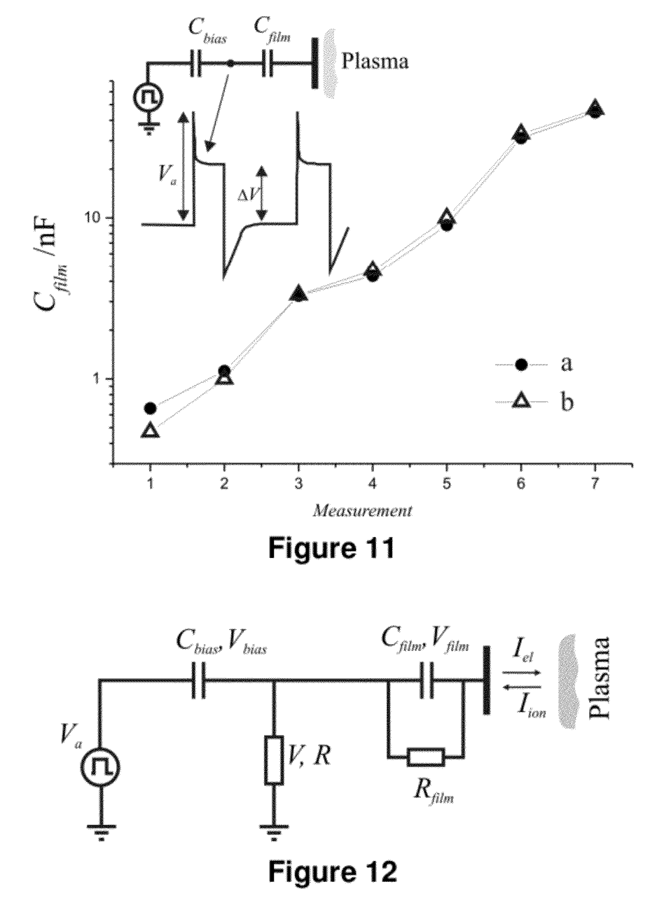

Measurement of the probe potential is done through a voltage divider formed by the biasing capacitor and the film capacitance (illustrated in FIG. 8). Because of that, although at the end of both parts of the pulse (i.e. the positive and the negative) the probe surface is at the floating potential, in the case of the positive pulse, a higher potential is measured, and in the case of the negative pulse, a lower potential is measured. Comparing these two values and knowing the biasing capacitance, it is possible to calculate the capacitance of the film using equation (4):

$${C}_{film} = {C}_{bias} \frac{{V}_{α} - Δ V}{Δ V} \qquad ( 4 )$$

wherein C_{film} is the capacitance of the film, C_{bias}, the capacitance of the biasing capacitor, ΔV the difference in the measured floating potentials and Vₐ the amplitude of the DC-pulse applied. The formula (4) above was confirmed experimentally by using a clean probe (i.e. without dielectric film and capacitance) and by inserting an additional capacitor in series with the biasing capacitor that acted as a dielectric film capacitance. The results for several different capacitors are shown in FIG. 11. As shown, values of the “film capacitance” calculated from the measured potential at the biasing capacitor are in good agreement with the actual value of the capacitors used.

Measurements with a real film formation shown in FIG. 10 confirm sensitivity of the method in one embodiment for measurements of the film capacitance. Further if the properties of the film material are known (e.g. its dielectric constant) the film thickness can be determined. The method in one embodiment allows thus in-situ measurement and/or in-situ monitoring of the film thickness.

Advantageously, the whole grounded electrode can be used as a probe. In that case, the grounded probe should not be grounded directly but through a biased capacitor and the pulse generator. The electrode, now acting as a probe, could be grounded and only during periodical short measurements (e.g. for duration of 1 ms every 100 ms) a DC pulse would be supplied to it and measurements obtained.

In this way more accurate measurements of the total ion flux to the probe could be done with even smaller perturbation of the plasma because the electrode would remain uniform (i.e. there would be no additional probe implemented in the grounded electrode).

In the case the film is not a pure dielectric material but has a certain resistivity (a ‘leaky’ film), the equation (4) cannot be applied as such. Values of both the film capacitance and the film resistance can still be obtained by comparing the measured data with numerical simulations.

The measured data can be successfully compared with results of numerical simulations performed in Wolfram Mathematica 7.0, but can be performed as well with any other suitable software.

As it is already mentioned, a dielectric film on the probe acts as an additional capacitor in series with the biasing capacitor. In reality the film is not an ideal capacitor, but a better representation would be a capacitor with a resistor in parallel as it is shown in the equivalent circuit of FIG. 12), which can be used for the numerical simulations. Although the additional capacitor should not have any significant effect on the ion flux, it affects the measurement of the I-V curve in two ways. First, the total capacitance of the circuit is smaller (two capacitors in series) so the charging/discharging with the same flux is faster. Also the potential is not read any more directly on the probe surface which is in contact with the plasma (and that is actually potential that determines I-V characteristic) but through a kind of voltage divider formed by the biasing capacitor (C_{bias}) and the film capacitance (C_{film}). These two capacitors are not charged/discharged with the same speed or even with the same sign during the whole pulse so the potential divider formed by them does not have a constant ratio which implies that the relation between the measured and actual potential is also not constant.

The discharging of the capacitor and the film can be represented by the following differential equations:

$$\begin{matrix}{C}_{bias} \frac{d {V}_{bias}}{d t} = - {I}_{ion} + {I}_{e} ( {V}_{α} - {V}_{bias} - {V}_{film} ) + \frac{{V}_{α} - {V}_{bias}}{R} & ( 5 ) \\ {C}_{film} \frac{d {V}_{film}}{d t} = - {I}_{ion} + {I}_{e} ( {V}_{α} - {V}_{bias} - {V}_{film} ) + \frac{{V}_{film}}{{R}_{film}} & ( 6 )\end{matrix}$$

wherein Vₐ is the applied pulse, V_{bias} is the potential at the biasing capacitor, V_{bias} is the potential at the dielectric film, Iᵢₒₙ ion current, Iₑ electron current and the other variables as presented in FIG. 12. The electron current is a function of the potential at the probe surface in contact with the plasma and it is given by:

$$I {γ}_{e} ( V ) = I {γ}_{e α} exp ( - \frac{{V}_{p} - V}{kT} ) \qquad ( 7 )$$

Results of simulation are shown in FIG. 16. In the case of a ‘leaky’ film the measured data should be compared with simulations with different values of film resistance and capacitance. Final values for the real film capacitance and the resistance are given by the values used for the numerical simulation with the best matching of measured and simulated data.

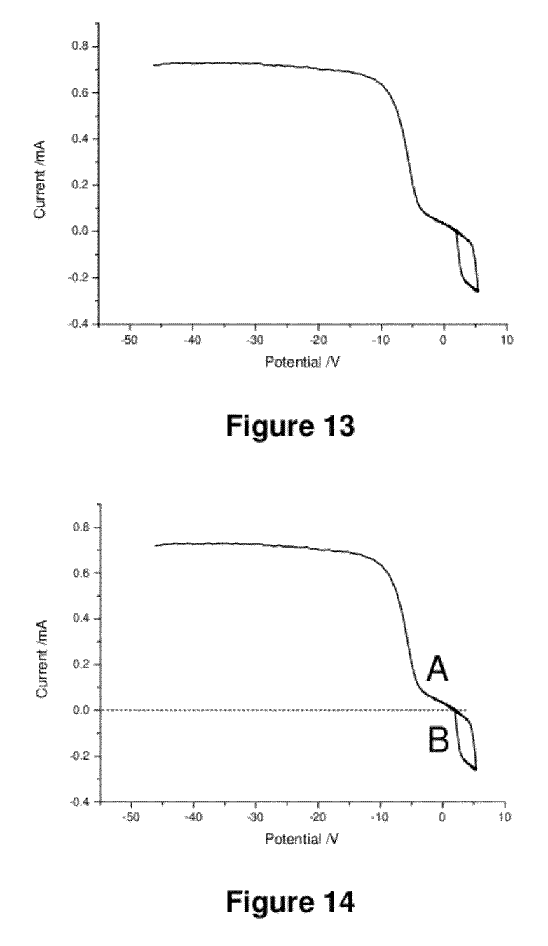

This approach is experimentally tested by comparing measurements on a setup according to FIG. 1, with a film deposited on the probe, and on a setup mimicking a film by a real capacitor in parallel with a resistor (with known values of capacitance and resistivity) connected in series with a clean probe. The additional capacitor and resistor were added in series with the biasing capacitor, at the place of the Cfilm and Rfilm in FIG. 12. The resulting I/V-curves are shown in FIGS. 13-16.

FIG. 13 shows an I-V curve obtained from real measurements on a probe covered with a dielectric layer (silicon oxide layer on top of silicon made probe) in Argon+0.5% oxygen plasma at 120 mTorr and 800 W 27 MHz CCP reactor.

FIG. 14 shows the same I-V curve as in FIG. 13, but with marked the regions A and B. The region A can be obtained with both DC and RF pulsing, but the region B which can be obtained only by DC pulsing. A hysteresis in the region B is a clear sign that the probe (and other walls including the grounded electrode) are coated with a dielectric layer. The area of the hysteresis can be an indication of the thickness of the dielectric layer.

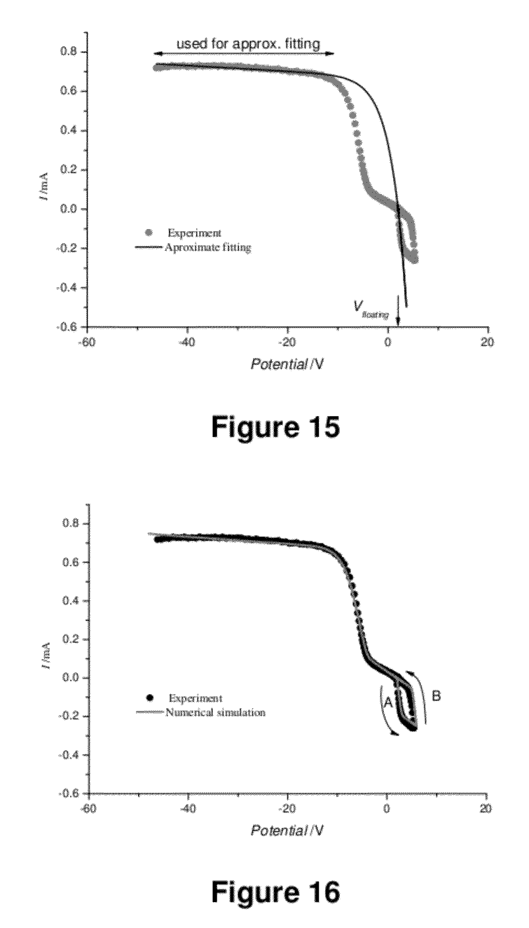

FIGS. 15 and 16 shows experimental data which are the same as in FIG. 13 on which in a first step (FIG. 15) approximate fitting is done, using equation (2), by fixing the floating potential to the measured value at which the current is equal to 0 and by fixing the electron temperature to 3 eV, and on which in a second step a more accurate fitting is done, using equations (5) and (6) for different values of film resistance and capacitance and then selecting the best fit.

Certain embodiments may be listed as follows.

A method for monitoring a plasma in a plasma reactor, comprising measuring a plasma parameter data at a surface in contact with the plasma by measuring the discharge rate of a biasing capacitor connected between a DC-voltage source for applying a DC-bias and a single planar Langmuir probe in contact with the plasma.

The method of the above wherein the plasma parameter data consists of at least one of an ion flux or an electron flux.

The method of any of the above, wherein the plasma parameter data consists of both an ion flux and an electron flux separately measured.

The method of any of the above, wherein the single probe has a common ground potential with the plasma reactor.

The method of any of the above, wherein applying a DC-bias consists of periodically supplying the single probe with a DC-pulse.

The method of any of the above, wherein measuring the electron and ion flux is performed during the charging and, respectively, the discharging of the biasing capacitor.

The method of any of the above, wherein the DC-pulse is a positive pulse or a negative pulse or it comprises both a positive and a negative part.

A device for measuring a plasma parameter data in a chamber constituting a plasma reactor, comprising:

a single Langmuir probe inside the chamber, the single probe having a planar surface

a biasing capacitor external to the chamber mounted in series between the supplying means and the single probe;

means external to the chamber for periodically measuring the discharge current of the biasing capacitor and the potential at the single probe and at the biasing capacitor during its discharge, and

means external to the chamber for periodically supplying the single probe with DC-pulses through the biasing capacitor.

A device according to the above, wherein the supplying means are comprised of a DC-source which provides the DC-pulses, the DC-pulses having a period and a duty cycle arranged such that the measurement of the discharge current and the potential at the single probe can be performed between two subsequent DC-pulses.

A device for measuring a plasma parameter data in a chamber constituting a plasma reactor comprising a plurality of single Langmuir probes arranged to function as above, thereby gathering information about the spatial distribution of the plasma parameter inside the chamber.

A method for measuring in-situ a capacitance of a dielectric film deposited in a plasma reactor on a surface in contact with plasma, using the device of the above, the method comprising:

a. periodically supplying the single probe with a DC-pulse through the biasing capacitor, wherein the DC-pulse comprises both a positive and a negative part,

b. measuring the floating potential during the positive part of the DC-pulse and the floating potential during the negative part of the DC-pulse,

c. calculating the difference (ΔV) between the measured floating potential during the positive part of the DC-pulse and the floating potential during the negative part of the DC-pulse,

d. calculating the capacitance of the dielectric film (C_{film}) using the difference (ΔV), the amplitude of the DC-pulse (Va) and the capacitance of the biasing capacitor (C_{bias}).

The method of the above, wherein the thickness of the dielectric film is monitored in-situ using the capacitance of the dielectric film and knowing the physical characteristics of the dielectric film.

The foregoing description details certain embodiments of the disclosure. It will be appreciated, however, that no matter how detailed the foregoing appears in text, the disclosure may be practiced in many ways. It should be noted that the use of particular terminology when describing certain features or aspects of the disclosure should not be taken to imply that the terminology is being re-defined herein to be restricted to including any specific characteristics of the features or aspects of the disclosure with which that terminology is associated.

While the above detailed description has shown, described, and pointed out novel features of the disclosure as applied to various embodiments, it will be understood that various omissions, substitutions, and changes in the form and details of the device or process illustrated may be made by those skilled in the technology without departing from the spirit of the disclosure.

What is claimed is:

1. A method of monitoring a plasma in a chamber of a plasma reactor, the method comprising measuring plasma parameter data at a surface of a single planar Langmuir probe in contact with the plasma, the plasma parameter data measuring comprising:
biasing a biasing capacitor connected between the single planar Langmuir probe and a bias source adapted to apply the biasing, wherein the biasing comprises applying a DC-bias; and
subsequently measuring a discharge current of the biasing capacitor as a result of the biasing, and a probe potential at the single probe during the discharge.

2. The method of claim 1, wherein the biasing comprises applying at least once a positive DC voltage level suitable for charging the biasing capacitor above a floating potential of the plasma, and wherein the measured plasma parameter data comprises at least one of an electron flux from the plasma to the probe and an ion flux from the plasma to the probe.

3. The method of claim 1, wherein the biasing comprises applying at least once a negative DC voltage level suitable for charging the biasing capacitor below a floating potential of the plasma, wherein the measured plasma parameter data comprises at least one of an electron flux from the plasma to the probe and an ion flux from the plasma to the probe.

4. The method of claim 1, wherein the biasing comprises applying a signal comprising positive DC-pulses, suitable for charging the biasing capacitor above a floating potential of the plasma, alternating with negative DC-pulses suitable for charging the biasing capacitor below a floating potential of the plasma, wherein the measured plasma parameter data comprises an electron flux from the plasma to the probe during the positive DC-pulses and an ion flux from the plasma to the probe during the negative DC-pulses.

5. The method of claim 4, wherein the signal is symmetrical relative to the floating potential.

6. The method of claim 4, wherein the positive, respectively negative DC-pulses have a predefined period and a duty cycle arranged such that the measurement of the discharge current and the potential at the single probe can be performed between two subsequent positive, respectively negative DC-pulses.

7. The method of claim 1, wherein the DC-bias has a positive ramp to limit electron current from the plasma to the probe at the beginning of the biasing.

8. The method of claim 1, wherein the single probe has a common ground potential with the plasma reactor.

9. The method of claim 1, further comprising fitting a measured I-V-curve on a simulated I-V-curve to determine presence or thickness of a dielectric film on the probe surface.

10. A device for monitoring a plasma in a chamber of a plasma reactor, comprising:
a single planar Langmuir probe inside the chamber having a surface for entering in contact with the plasma;
a biasing capacitor external to the chamber mounted in series between the single Langmuir probe;
a bias source for biasing the biasing capacitor; and
a measuring module configured to measure a discharge current of the biasing capacitor as a result of the biasing, and a probe potential at the single probe during the discharge,
wherein the bias source is a DC-bias source adapted for applying a DC-bias.

11. The device of claim 10, wherein the DC-bias source is adapted for applying at least once a positive DC voltage level suitable for charging the biasing capacitor above a floating potential of the plasma, wherein the measuring module is configured to measure at least one of an electron flux from the plasma to the probe and an ion flux from the plasma to the probe.

12. The device of claim 10, wherein the DC-bias source is configured to apply at least once a negative DC voltage level suitable for charging the biasing capacitor below a floating potential of the plasma, wherein the measuring module is configured to measure at least one of an electron flux from the plasma to the probe and an ion flux from the plasma to the probe.

13. The device of claim 10, wherein the DC-bias source is adapted for applying a signal to the biasing capacitor comprising positive DC-pulses suitable for charging the biasing capacitor above a floating potential of the plasma alternating with negative DC-pulses suitable for charging the biasing capacitor below a floating potential of the plasma, and wherein the measuring module is configured to measure an electron flux from the plasma to the probe during the positive DC-pulses and an ion flux from the plasma to the probe during the negative DC-pulses.

14. The device of claim 10, wherein the DC-bias has a positive ramp to limit electron current from the plasma to the probe at the beginning of the biasing.

15. The device of claim 10, wherein the single probe has a common ground potential with the plasma reactor.

16. The device of claim 10, wherein the measuring module is further configured to fit a measured I-V-curve on a simulated I-V-curve to determine presence or thickness of a dielectric film on the probe surface.

17. A plasma reactor comprising a plurality of plasma monitoring devices according to claim 10 to gather information about the spatial distribution of at least one plasma parameter inside the chamber.

18. A method of measuring in-situ a capacitance of a dielectric film deposited on a surface of a single Langmuir probe which is located inside a chamber of a plasma reactor in contact with a plasma, the method comprising:
a) alternatingly providing the single Langmuir probe with positive and negative DC-pulses through a biasing capacitor, the positive DC-pulses being suitable for charging the biasing capacitor above a floating potential of the plasma and the negative DC-pulses being suitable for charging the biasing capacitor below a floating potential of the plasma;
b) measuring a first probe potential during the positive DC-pulses and a second probe potential during the negative DC-pulses;
c) calculating the difference (ΔV) between the measured first floating potential and the measured second floating potential; and
d) calculating the capacitance of the dielectric film (C_{film}) using the calculated difference (ΔV), the amplitude of the DC-pulses (Va) and the capacitance of the biasing capacitor (C_{bias}).

19. The method of claim 18, further comprising determining the thickness of the dielectric film using the capacitance of the dielectric film (C_{film}) and known physical characteristics of the dielectric film.
